(19) United States
(12) Patent Application Publication
(10) Pub. No.: US 2025/0330898 A1
(43) Pub. Date: Oct. 23, 2025

(54) METHOD FOR WIRELESS COMMUNICATION, AND RELAY TERMINAL AND CORE NETWORK ELEMENT

(71) Applicant: GUANGDONG OPPO MOBILE TELECOMMUNICATIONS CORP., LTD., Dongguan (CN)

(72) Inventors: Fei LU, Dongguan (CN); Haorui YANG, Dongguan (CN); Yali GUO, Dongguan (CN)

(21) Appl. No.: 18/994,031

(22) PCT Filed: Dec. 10, 2021
(86) PCT No.: PCT/CN2021/137258

§ 371 Date: Jan. 13, 2025

(51) Int. Cl. H04W 48/16; H04W 84/12; H04W 88/04

(52) U.S. Cl. CPC H04W 48/16; H04W 84/12; H04W 88/04

(57) ABSTRACT

Provided is a method for wireless communication. The method is applicable to a relay terminal, and the method includes: transmitting a session report to a core network element; wherein the session report includes at least one of: an identifier of a PDU session, an identifier of a remote terminal, or a non-3GPP access mode used by the remote terminal to access the relay terminal.

### CROSS-REFERENCE TO RELATED APPLICATION

This application is a US national stage of international application No. PCT/CN2021/137258, filed on Dec. 10, 2021, the entire contents of which are incorporated herein by reference.

### TECHNICAL FIELD

Embodiments of the present disclosure relate to the field of communications, and in particular, relate to a method for wireless communication, and a remote terminal and a relay terminal.

### RELATED ART

Until now, during the process of connecting a remote terminal to a 5^{th} generation (5G) network via a relay terminal, a new radio (NR)-based PC5 connection needs to be established between the remote terminal and the relay terminal.

### SUMMARY

Embodiments of the present disclosure provide a method for wireless communication, and a remote terminal and a relay terminal.

In some embodiments of the present disclosure, a method for wireless communication is provided. The method includes:
transmitting a direct communication request message to a relay terminal over a connection established between a remote terminal and the relay terminal based on a non-3^{rd} Generation Partnership Project (3GPP) access mode; and
receiving a direct communication accept message from the relay terminal.

In some embodiments of the present disclosure, a method for wireless communication is provided. The method includes:
receiving a direct communication request message from a remote terminal over a connection established between the remote terminal and a relay terminal based on a non-3GPP access mode; and
transmitting a direct communication accept message to the remote terminal.

In some embodiments of the present disclosure, a method for wireless communication is provided. The method includes:

receiving a session report from a relay terminal, wherein the session report includes at least one of: an identifier of a protocol data unit (PDU) session, an identifier of a remote terminal, or a non-3GPP access mode used by the remote terminal to access the relay terminal.

In some embodiments of the present disclosure, a remote terminal is provided. The remote terminal is configured to perform the method described above or methods according to embodiments thereof. Specifically, the remote terminal includes one or more functional modules configured to perform the method described above or methods according to embodiments thereof.

In some embodiments, the remote terminal includes a processing unit configured to implement a function related to information processing. For example, the processing unit is a processor.

In some embodiments, the remote terminal includes a transmitting unit and/or a receiving unit. The transmitting unit is configured to implement a function related to transmission, and the receiving unit is configured to implement a function related to reception. For example, the transmitting unit is a transmitter, and the receiving unit is a receiver. For example, the remote terminal is a communication chip, the receiving unit is an input circuit or an interface of the communication chip, and the transmitting unit is an output circuit or an interface of the communication chip.

In some embodiments of the present disclosure, a relay terminal is provided. The relay terminal is configured to perform the method described above or methods according to embodiments thereof. Specifically, the relay terminal includes one or more functional modules configured to perform the method described above or methods according to embodiments thereof.

In some embodiments, the relay terminal includes a processing unit configured to implement a function related to information processing. For example, the processing unit is a processor.

In some embodiments, the relay terminal includes a transmitting unit and/or a receiving unit. The transmitting unit is configured to implement a function related to transmission, and the receiving unit is configured to implement a function related to reception. For example, the transmitting unit is a transmitter, and the receiving unit is a receiver. For example, the relay terminal is a communication chip, the receiving unit is an input circuit or an interface of the communication chip, and the transmitting unit is an output circuit or an interface of the communication chip.

In some embodiments of the present disclosure, a core network element is provided. The core network element is configured to perform the method described above or methods according to embodiments thereof. Specifically, the core network element includes one or more functional modules configured to perform the method described above or methods according to embodiments thereof.

In some embodiments, the core network element includes a processing unit configured to implement a function related to information processing. For example, the processing unit is a processor.

In some embodiments, the core network element includes a transmitting unit and/or a receiving unit. The transmitting unit is configured to implement a function related to transmission, and the receiving unit is configured to implement a function related to reception. For example, the transmitting unit is a transmitter, and the receiving unit is a receiver. For example, the core network element is a communication chip, the receiving unit is an input circuit or an interface of the communication chip, and the transmitting unit is an output circuit or an interface of the communication chip.

In some embodiments of the present disclosure, a communication device is provided. The communication device includes a processor and a memory. The memory is configured to store one or more computer programs, and the processor is configured to load and run the one or more computer programs stored in the memory to perform the method described above or methods according to embodiments thereof.

In some embodiments, one or more processors are configured, and one or more memories are configured.

In some embodiments, the memory may be integrated with the processor or provided separate from the processor.

In some embodiments, the communication device further includes a transmitter and a receiver.

In some embodiments of the present disclosure, a chip is provided. The chip is configured to perform the method described above or methods according to embodiments thereof. Specifically, the chip includes a processor. The processor is configured to load and run one or more computer programs from a memory, to cause a device equipped with the chip to perform the method described above or methods according to embodiments thereof.

In some embodiments of the present disclosure, a computer-readable storage medium is provided. The computer-readable storage medium is configured to store one or more computer programs. The one or more computer programs, when loaded and run on a computer, cause the computer to perform the method described above or methods according to embodiments thereof.

In some embodiments of the present disclosure, a computer program product is provided. The computer program product includes one or more computer program instructions. The one or more computer program instructions, when loaded and executed by a computer, cause the computer to perform the method described above or methods according to embodiments thereof.

In some embodiments of the present disclosure, a computer program is provided. The computer program, when loaded and run on a computer, causes the computer to perform the method described above or methods according to embodiments thereof.

### BRIEF DESCRIPTION OF THE DRAWINGS

FIG. 1 is a schematic diagram of a communication system according to some embodiments of the present disclosure;

FIG. 2 is a schematic diagram of a system architecture in which a remote terminal is connected to a 5G network via a relay terminal according to some embodiments of the present disclosure;

FIG. 3 is a schematic diagram of a discovery process of a model A according to some embodiments of the present disclosure;

FIG. 4 is a schematic diagram of a discovery process of a model B according to some embodiments of the present disclosure;

FIG. 5 is a schematic flowchart of a method for wireless communication according to some embodiments of the present disclosure;

FIG. 6 is a schematic flowchart of a method for wireless communication according to some embodiments of the present disclosure;

FIGS. 7 to 10 are schematic flowcharts of a method for wireless communication according to some embodiments of the present disclosure;

FIG. 11 is a schematic block diagram of a remote terminal according to some embodiments of the present disclosure;

FIG. 12 is a schematic block diagram of a relay terminal according to some embodiments of the present disclosure;

FIG. 13 is a schematic block diagram of a core network element according to some embodiments of the present disclosure;

FIG. 14 is a schematic block diagram of a communication device according to some embodiments of the present disclosure; and

FIG. 15 is a schematic block diagram of a chip according to some embodiments of the present disclosure.

### DETAILED DESCRIPTION

The technical solutions in embodiments of the present disclosure will be described hereinafter in conjunction with the accompanying drawings.

The technical solutions according to the embodiments of the present disclosure may be applicable to various communication systems, including but not limited to, a global system for mobile communications (GSM), a code division multiple access (CDMA) system, a wideband code division multiple access (WCDMA) system, a general packet radio system (GPRS) system, a long-term evolution (LTE) system, an advanced LTE (LTE-A) system, a new radio (NR) system, an evolution system of the NR system, an LTE-based access to unlicensed spectrum (LTE-U) system, an NR-based access to unlicensed spectrum (NR-U) system, a non-terrestrial network (NTN) system, a universal mobile telecommunication system (UMTS), a wireless local area network (WLAN) system, a wireless fidelity (Wi-Fi) system, a next-generation communication system, or other communication systems.

Generally, a conventional communication system supports a limited quantity of connections and is easy to implement. However, with development of communication technologies, a mobile communication system supports device-to-device (D2D) communications, machine-to-machine (M2M) communications, machine-type communications (MTC), vehicle-to-vehicle (V2V) communications, vehicle-to-everything (V2X) communications, and the like in addition to conventional communication. The communication systems are applicable to the embodiments of the present disclosure.

In some embodiments, the communication system in the embodiments of the present disclosure may be applicable to a carrier aggregation (CA) scenario, a dual connectivity (DC) scenario, or a standalone (SA) networking scenario.

The embodiments of the present disclosure do not limit the spectrum used. For example, the embodiments of the present disclosure are applicable to a licensed spectrum as well as an unlicensed spectrum.

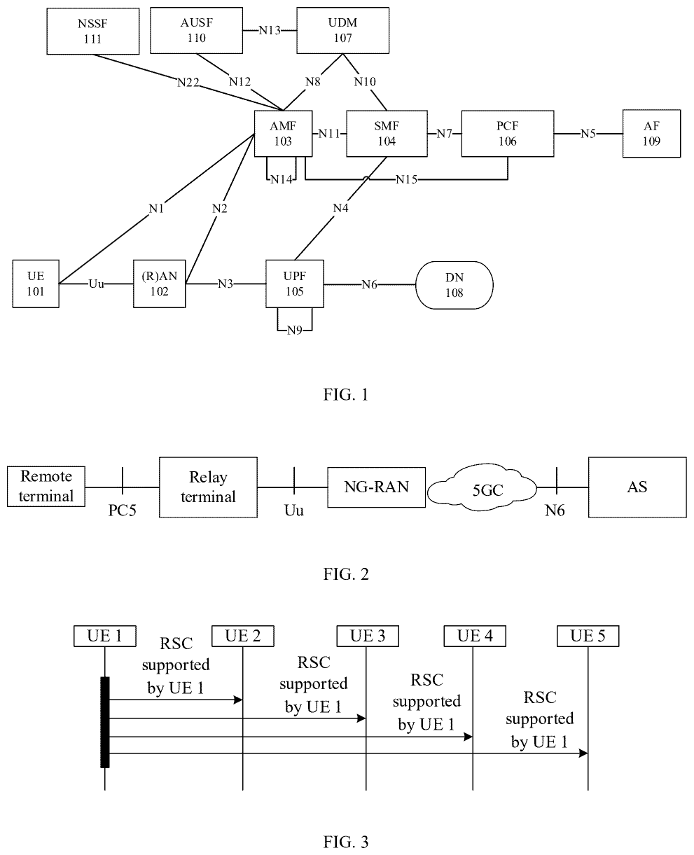

FIG. 1 exemplarily illustrates a schematic diagram of a communication system 100 to which the present disclosure is appliable.

As illustrated in FIG. 1, the communication system 100 mainly includes a terminal device (a user equipment, UE) 101, an access network (AN) device 102, an access and mobility management function (AMF) entity 103, a session management function (SMF) entity 104, a user plane function (UPF) entity 105, a policy control function (PCF) entity 106, a unified data management (UDM) entity 107, a data network (DN) 108, an application function (AF) entity 109, an authentication server function (AUSF) entity 110, and a network slice selection function (NSSF) entity 111.

In some embodiments, in the communication system 100, the UE 101 establishes an access stratum connection to the AN device 102 over a Uu interface to implement access stratum messages interaction and wireless data transmission. The UE 101 establishes a non-access stratum (NAS) connection to the AMF entity 103 over an N1 interface to implement NAS messages interaction. The AN device 102 is connected to the AMF entity 103 over an N2 interface, and connected to the UPF entity 105 over an N3 interface. A plurality of UPF entities 105 are connected to each other over an N9 interface, and the UPF entity 105 is connected to the DN 108 over an N6 interface, and connected to the SMF entity 104 over an N4 interface. The SMF entity 104 is connected to the PCF entity 106 over the N7 interface, and connected to the UDM entity 107 over an N10 interface. The SMF entity 104 controls the UPF entity 105 over the N4 interface, and the SMF entity 104 is connected to the AMF entity 103 over an N11 interface. A plurality of AMF entities 103 are connected to each other over an N14 interface, and the AMF entity 103 is connected to the UDM entity 107 over an N8 interface, connected to the AUSF entity 110 over an N12 interface, connected to the NSSF entity 111 over an N22 interface, and connected to the PCF entity 106 over an N15 interface. The PCF entity 106 is connected to the AF entity 109 over an N5 interface. The AUSF entity 110 is connected to the UDM entity 107 over an N13 interface.

In the communication system 100, the UDM entity 107 is a subscription database within the core network, storing the subscription data of users in the 5G network. The AMF entity 103 is the mobility management function within the core network, and the SMF entity 104 is the session management function within the core network. Besides performing the mobility management on the UE 101, the AMF entity 103 is also responsible for forwarding session management-related messages between the UE 101 and the SMF entity 104. The PCF entity 106 is the policy management function within the core network, and responsible for formulating policies related to mobility management, session management, charging, and the like for the UE 101. The UPF entity 105 is the user plane function within the core network, conducting data transmission with external data networks over the N6 interface and with the AN device 102 over the N3 interface. Upon accessing the 5G network over the Uu interface, the UE 101 establishes a protocol data unit (PDU) session data connection from the UE 101 to the UPF entity 105 under the control of the SMF entity 104 to transmit data. The AMF entity 103 and the SMF entity 104 acquire user subscription data from the UDM entity 107 over the N8 and N10 interfaces, respectively, and acquire policy data from the PCF entity 106 over the N15 and N7 interfaces, respectively.

Additionally, the communication system 100 includes a network exposure function (NEF) entity, which is configured to transmit information with a third-party application server interface between a core network node and a third-party application.

It should be understood that a device with a communication function in the networks/systems in the embodiments of the present disclosure is referred to as a communication device. It should be noted that the communication system 100 is illustrated using a 5G communication system as an example. However, the present disclosure may also be applicable to other 3GPP communication systems, such as a 4^{th} generation (4G) communication system, or future 3GPP communication systems, which is not limited in the present disclosure. It should be understood that the terms “system” and “network” herein are often used interchangeably. The term “and/or” herein merely describes an association relationship between associated objects, and indicates that three types of relationships may exist. For example, the phrase “A and/or B” means (A), (B), or (A and B). In addition, the symbol “/” herein generally indicates an “or” relationship between the associated objects.

The embodiments of the present disclosure are described in conjunction with a terminal device and a network device. The terminal device may also be referred to as a user equipment (UE), an access terminal, a subscriber unit, a subscriber station, a rover station, a mobile station, a remote station, a remote terminal, a mobile device, a user terminal, a terminal, a wireless communication device, a user agent, a user device, or the like. The terminal device may be a station (ST) in a WLAN, a cellular phone, a cordless phone, a Session Initiation Protocol (SIP) phone, a wireless local loop (WLL) ST, a personal digital assistant (PDA), a handheld device with a wireless communication function, a computing device or another processing device connected to a wireless modem, a vehicle-mounted device, a wearable device, a terminal device in a next-generation communication system such as an NR network, a terminal device in a future evolved public land mobile network (PLMN), or the like.

By way of example but not limitation, in the embodiments of the present disclosure, the terminal device may alternatively be a wearable device. The wearable device may also be referred to as a wearable intelligent device, and is a generic name of wearable devices such as glasses, gloves, watches, clothing, or shoes, which are intelligently designed and developed for daily wear using wearable technologies. The wearable device is a portable device that is directly worn or integrated into a user's clothing or accessories. The wearable device is not only a hardware device, but also implements powerful functions by software support, data interaction, and cloud interaction. The wearable intelligent devices in a broad sense include devices such as smart watches or smart glasses that have full functionality and large size, and are capable of implementing all or part of functionality without depending on the smart phone, and devices such as various kinds of smart bracelets and smart jewelries for monitoring physical signs, which are dedicated to a specific type of application functions and need to be used in conjunction with other devices like the smart phone.

In some embodiments of the present disclosure, the AN device 102 may be a device for communicating with a mobile device. The AN device 102 may be an access point (AP) in a WLAN, a base transceiver station (BTS) in a GSM or CDMA system, a NodeB (NB) in a WCDMA system, an evolved NodeB (eNB or eNodeB) in an LTE system, a relay station, an AP, a vehicle-mounted device, a wearable device, a gNodeB (gNB) in an NR network, a network device in a future evolved PLMN, or the like.

In the embodiments of the present disclosure, the network device may provide services for a cell. A terminal device communicates with the network device over transmission resources (for example, frequency domain resources or spectrum resources) used by the cell. The cell may be a cell corresponding to the network device (for example, a base station). The cell may belong to a macro base station or a base station corresponding to a small cell. The small cell may include a metro cell, a micro cell, a pico cell, a femto cell, or the like. The small cell features small coverage and low transmit power, and is suitable for providing high-rate data transmission services.

With the continuous development of 5G applications, network controlled interactive services (NCIS), as a new service pattern, has been introduced into a standard for related standardization services. The NCIS is mainly directed to applications such as AR/VR and games, and thus imposes stricter requirements for service quality such as rate, time delay, packet loss rate and high-speed coding and decoding. For example, for VR games, the data rate needs to reach 10 Gbps, and the packet loss rate may not exceed 10E-4. The session established for the NCIS service is an NCIS session, and UEs in the same NCIS session may be considered to form an NCIS group, for example, a team in a game.

In some embodiments, proximity service communication, such as NCIS communication, may be designed using 5G proximity based service (ProSe). An important scenario for proximity based service is the scenario of UE-to-network (U2N) relay. The U2N relay is to relay transmission data for a remote terminal via a relay terminal, such that the remote terminal is capable of communicating with the network. That is, a terminal device with the ProSe capability may communicate directly with another terminal device with the ProSe capability over a PC5 interface. In the case that a terminal device may be connected to an external data network over the 5G network and has the ProSe capability, the terminal device may serve as a relay terminal, and another remote terminal with the ProSe capability may establish a direct connection with the relay UE over the PC5 interface and interact with the external network over a PDU session established between the relay terminal and the 5G network.

FIG. 2 is a schematic diagram of a system architecture in which a remote terminal is connected to a 5G network via a relay terminal according to some embodiments of the present disclosure.

As illustrated in FIG. 2, the remote terminal is connected to the relay terminal via a PC5 interface, and the relay terminal is connected to a next generation radio access network (NG-RAN) over a Uu interface, thus enabling connection to a 5G core network (5GC), and 5GC is connected to an application server (AS) over an N6 interface. That is, a PC5 connection is established between the remote terminal and the relay terminal, and the relay terminal relays data from the remote terminal for the remote terminal using a PDU session. Since each PDU session corresponds to a type, for example, IPv4, IPV6, IPv4v6, Ethernet, or Unstructured, for data of a specific type, transmission is performed using a corresponding PDU session.

It should be noted that FIG. 2 is illustrated using a 5G communication system as an example. However, other 3GPP communication systems may also be applicable, for example, a 4G communication system, or a future 3GPP communication system, which is not limited in the present disclosure. In addition, in the embodiments of the present disclosure, the application server (AS) in FIG. 2 may also be other terminal devices or an external public safety Internet. It should be noted that the relay terminal establishes a PDU session with the 5G network, and the remote terminal performs data interaction with the external network over the PDU session of the relay terminal.

In order to implement relay communication, necessary configuration parameters for the relay terminal and the remote terminal need to be obtained before relay communication is performed. These configuration parameters may come from a policy control function (PCF) or an application server, or may be pre-configured on the terminal or in a subscriber identity module (SIM). The remote terminal needs to discover a suitable relay terminal and establish a PC5 connection with the relay terminal before transmitting data. The relay discovery may include a discovery process of model A or model B.

In the discovery process of model A, the relay terminal actively broadcasts a relay service code (RSC) supported by the relay terminal, and the remote terminal does not need to feed back a response message. The RSC may be used for determining that the relay terminal is capable of providing a relay service. FIG. 3 is a schematic diagram of a discovery process of model A according to some embodiments of the present disclosure. As illustrated in FIG. 3, UE 1 serves as a relay terminal, and UE 2 to UE 5 serve as remote terminals. In the discovery process, UE 1 broadcasts RSC supported by UE 1, and after receiving the RSC broadcast by UE 1, UE 2 to UE 5 directly use UE 1 as the discovered relay terminal or determine whether to use UE 1 as the discovered relay terminal based on the RSC supported by UE 1. In this case, UE 2 to UE 5 do not need to feed back response messages.

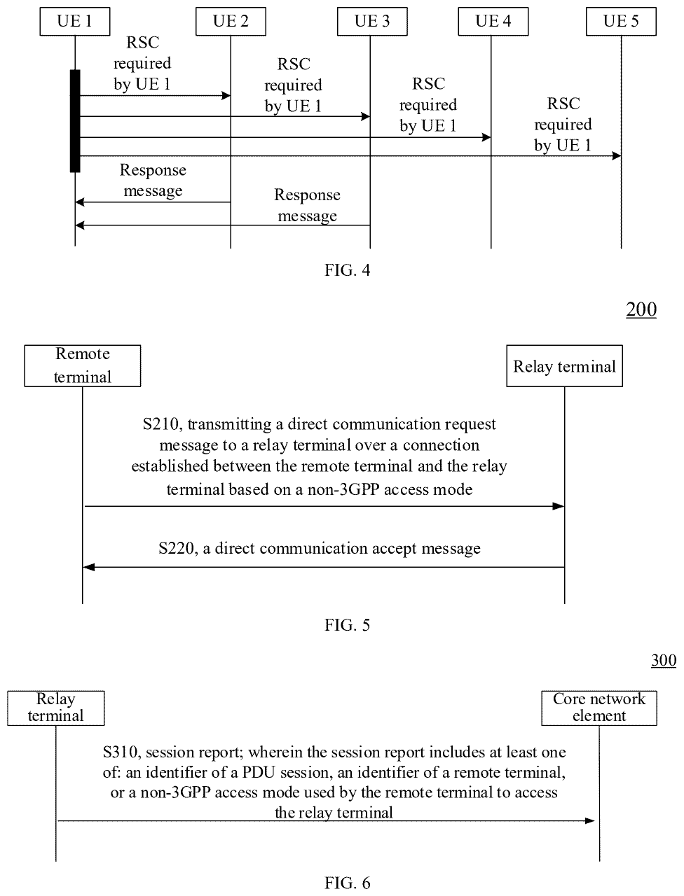

In the discovery process of model B, the remote terminal first broadcasts RSC required by the remote terminal, and in the case that a relay terminal capable of supporting the RSC required by the remote terminal exists around the remote terminal, the relay terminal replies to the remote terminal. FIG. 4 is a schematic diagram of a discovery process of model B according to some embodiments of the present disclosure. As illustrated in FIG. 4, UE 1 serves as a remote terminal, and UE 2 to UE 5 serve as relay terminals. In the discovery process, UE 1 first broadcasts RSC required by UE 1, and correspondingly, UE 2 to UE 5 receive the RSC broadcast by UE 1;assuming that only UE 2 and UE 3 support the RSC required by UE 1, after UE 2 to UE 5 receive the RSC broadcast by UE 1, only UE 2 and UE 3 need to feed back response messages to UE 1, while UE 4 and UE 5 do not need to feed back response messages, and correspondingly, after receiving the response messages from UE 2 and UE 3, UE 1 directly uses UE 2 and UE 3 as the discovered relay terminals.

After the discovery process, a PC5 connection is established between the relay terminal and the remote terminal.

In some embodiments, during the process of connecting the remote terminal to a 5G network via the relay terminal, an NR-based PC5 connection needs to be established between the remote terminal and the relay terminal. However, some limitations are present in the NR-based PC5 connection. For example, a proprietary frequency band needs to be used in the NR-based PC5 connection, that is, a frequency band planned in advance by standards organizations such as the International Telecommunication Union (ITU) needs to be used in the NR-based PC5 connection. This limits the development of the NR-based PC5 connection to some extent. For example, the NR-based PC5 connection is a new interface, and therefore the development of related products is difficult and the development cycle is long. Therefore, a method for wireless communication, which reduces the limitations in the connection between the remote terminal and the relay terminal during the process of connecting the remote terminal to the 5G network via the relay terminal and hence reduces the development difficulty and shortens the development cycle, is desired in the art.

In view of this, the embodiments of the present disclosure provide a method for wireless communication, and a remote terminal and a relay terminal, which reduces the limitations in the connection between the remote terminal and the relay terminal, such that the development difficulty is reduced and the development cycle is shortened.

FIG. 5 is a schematic flowchart of a method 200 for wireless communication according to some embodiments of the present disclosure. The method 200 is interactively applicable to a remote terminal and a relay terminal. The remote terminal illustrated in FIG. 5 is the remote terminal illustrated in FIG. 2, and the relay terminal illustrated in FIG. 5 is the relay terminal illustrated in FIG. 2.

As illustrated in FIG. 5, the method 200 includes the following processes.

In S210, a remote terminal transmits a direct communication request message to a relay terminal over a connection established between the remote terminal and the relay terminal based on a non-3GPP access mode.

In S220, the remote terminal receives a direct communication accept message from the relay terminal.

Exemplarily, the direct communication request message and the direct communication accept message are used for establishing a direct communication connection, i.e., a PC5 connection. That is, the direct communication request message and the direct communication accept message are also referred to as PC5 messages or PC5 signaling.

Exemplarily, the remote terminal transmits a direct communication request message to the relay terminal over a connection established between the remote terminal and the relay terminal based on a non-3GPP access mode, and receives a direct communication accept message from the relay terminal, so as to establish a PC5 connection between the remote terminal and the relay terminal based on the non-3GPP access mode.

In the embodiments, a non-3GPP access mode is introduced for establishment of a connection between the remote terminal and the relay terminal, and in the connection established between the remote terminal and the relay terminal based on the non-3GPP access mode, a direct communication request message is transmitted to the relay terminal and a direct communication accept message from the relay terminal is received. Since the commercial investment and cost of the non-3GPP access mode are lower than those of the NR-based access mode, and the use of a proprietary frequency band is not required, the method for wireless communication according to the present disclosure not only achieves the connection between the remote terminal and the 5G network via the relay terminal, but also reduces the limitations in the connection between the remote terminal and the relay terminal, such that the development difficulty is reduced and the development cycle is shortened.

In some embodiments, the direct communication request message includes first indication information and/or an identifier of the remote terminal, and the first indication information indicates whether the remote terminal has a capability of communicating with a 5G core network.

Exemplarily, the scenario whether the remote terminal has a capability of communicating with a 5G core network includes, but is not limited to: the case whether the remote terminal has a capability of safe communication with a 5G core network or the case whether the remote terminal has an authentication capability during the process of communicating with a 5G core network.

In some embodiments, in the case that the first indication information indicates that the remote terminal does not have a capability of communicating with a 5G core network, an identifier of the remote terminal is in a network access identifier (NAI) format; in the case that the first indication information indicates that the remote terminal has a capability of communicating with a 5G core network, an identifier of the remote terminal is a subscriber concealed identifier (SUCI).

Exemplarily, in the case that the first indication information indicates that the remote terminal does not have the capability of safe communication with the 5G core network, the identifier of the remote terminal is in the NAI format; and in the case that the first indication information indicates that the remote terminal has the capability of safe communication with the 5G core network, the identifier of the remote terminal is the SUCI.

Exemplarily, the first indication information indicates, by an information element, whether the remote terminal has a capability of communicating with a 5G core network. For example, the value of one bit in the information element is used for indicating whether the remote terminal has a capability of communicating with a 5G core network. For example, in the case that the value of the one bit is a first numerical value, the remote terminal has the capability of communicating with a 5G core network, and in the case that the value of the one bit is a second numerical value, the remote terminal does not have the capability of communicating with a 5G core network. In some embodiments, the first numerical value is 0 and the second numerical value is 1, and in some embodiments, the first numerical value is 1 and the second numerical value is 0.

Exemplarily, the NAI format is expressed as the format username@realm, and the NAI format is a subscriber identity identifier defined by the home network operator and is globally unique.

In some embodiments, the direct communication request message includes a PDU session parameter requested by the remote terminal.

In other words, the remote terminal indicates, over the direct communication request message, a PDU session parameter requested by the remote terminal to the relay terminal. Correspondingly, the relay terminal, in response to receiving the direct communication request message, establishes a PDU session based on the PDU session parameter in the direct communication request message.

In some embodiments, the direct communication accept message includes a PDU session parameter corresponding to the PDU session established by the relay terminal, or the direct communication accept message includes a PDU session parameter supported by the relay terminal.

In other words, the remote terminal does not need to indicate the PDU session parameter requested by the remote terminal to the relay terminal, that is, the relay terminal may directly use the established PDU session or establish a PDU session using the PDU session parameter supported by the relay terminal, and notify the remote terminal that the PDU session parameter used by the relay terminal is the PDU session parameter corresponding to the established PDU session or the PDU session parameter supported by the relay terminal.

In some embodiments, the PDU session parameter includes at least one of: a data network name (DNN), single-network slice selection assistance information (S-NSSAI), a session and service continuity (SSC) mode, or a type of a PDU session. Exemplarily, the type of the PDU session includes, but is not limited to: IPv4, IPV6, IPv4v6, Ethernet, or Unstructured.

In some embodiments, the method 200 further includes: acquiring an Internet Protocol (IP) address allocated by the relay terminal to the remote terminal during establishment of the connection between the remote terminal and the relay terminal based on the non-3GPP access mode.

Exemplarily, the remote terminal acquires an IP address allocated by the relay terminal to the remote terminal during establishment of the connection between the remote terminal and the relay terminal based on the non-3GPP access mode. Correspondingly, the relay terminal allocates an IP address to the remote terminal during establishment of the connection between the remote terminal and the relay terminal based on the non-3GPP access mode.

In some embodiments, the S210 includes: transmitting, on a PDU layer, the direct communication request message to the relay terminal.

Exemplarily, the remote terminal transmits, on a PDU layer, the direct communication request message to the relay terminal; correspondingly, the relay terminal receives, on the PDU layer, the direct communication request message from the remote terminal. In some embodiments, the PDU layer includes an IP layer.

In some embodiments, the method 200 further includes: transmitting a session report to an SMF or a UPF.

The session report includes at least one of: an identifier of a PDU session, an identifier of the remote terminal, or a non-3GPP access mode used by the remote terminal to access the relay terminal.

In the embodiments, by transmitting a session report to the SMF or the UPF, not only the control effect of the network on the remote terminal is improved, but also the resource utilization rate is improved. For example, in an actual use process, in the case that an intelligent terminal (e.g., a mobile phone) is used as a hotspot, and then a laptop computer or other mobile phones is connected to the internet via the intelligent terminal used as the hotspot, the intelligent terminal used as the hotspot reports a session report of the laptop computer or other mobile phones to an operator network, which is beneficial to improving the control of the operator network over the laptop computer or other mobile phones via the intelligent terminal, and in addition, is also beneficial to the operator to perceive the existence of the laptop computer or other mobile phones via the intelligent terminal, such that the abuse of network resources is avoided and the resource utilization rate is further improved.

In some embodiments, in the case that the direct communication request message includes an SUCI of the remote terminal, the session report includes the SUCI of the remote terminal.

Exemplarily, in the case that the remote terminal has a capability of communicating with a 5G core network, an identifier of the remote terminal in the session report is the SUCI.

In some embodiments, in the case that the direct communication request message includes an identifier in an NAI format of the remote terminal, the session report includes an SUCI generated by the relay terminal based on the identifier in the NAI format.

Exemplarily, in the case that the remote terminal does not have a capability of communicating with a 5G core network, an identifier of the remote terminal in the session report is an SUCI generated by the relay terminal based on the identifier in an NAI format.

In some embodiments, the non-3GPP access mode includes at least one of a WLAN access mode or a Bluetooth access mode.

In addition, in some embodiments, the non-3GPP access mode is another access mode, which is not specifically limited in the present disclosure.

FIG. 6 is a schematic flowchart of a method 300 for wireless communication according to some embodiments of the present disclosure. The method 300 is interactively applicable to a core network element and a relay terminal. The core network element may be an SMF or a UPF, for example, SMF 104 or UPF 105 illustrated in FIG. 1. The relay terminal illustrated in FIG. 6 may be a relay terminal illustrated in FIG. 2.

As illustrated in FIG. 6, the method 300 includes the following process.

In S310, a core network element receives a session report from a relay terminal.

The session report includes at least one of: an identifier of a PDU session, an identifier of a remote terminal, or a non-3GPP access mode used by the remote terminal to access the relay terminal.

In the embodiments, by transmitting a session report to the SMF or the UPF, not only the control effect of the network on the remote terminal is improved, but also the resource utilization rate is improved. For example, in an actual use process, in the case that an intelligent terminal (e.g., a mobile phone) is used as a hotspot, and then a laptop computer or other mobile phones is connected to the internet via the intelligent terminal used as the hotspot. In the embodiments, the intelligent terminal used as the hotspot reports a session report of the laptop computer or other mobile phones to an operator network, which is beneficial to improving the control of the operator network over the laptop computer or other mobile phones via the intelligent terminal, and in addition, is also beneficial to the operator to perceive the existence of the laptop computer or other mobile phones via the intelligent terminal, such that the abuse of network resources is avoided and the resource utilization rate is further improved.

In some embodiments, in the case that a direct communication request message from a remote terminal includes an SUCI of the remote terminal, the session report includes the SUCI of the remote terminal.

Exemplarily, in the case that the remote terminal has a capability of communicating with a 5G core network, an identifier of the remote terminal in the session report is the SUCI.

In some embodiments, in the case that a direct communication request message from a remote terminal includes an identifier in an NAI format of the remote terminal, the session report includes an SUCI generated by the relay terminal based on the identifier in an NAI format.

Exemplarily, in the case that the remote terminal does not have a capability of communicating with a 5G core network, an identifier of the remote terminal in the session report is an SUCI generated by the relay terminal based on the identifier in an NAI format.

In some embodiments, the non-3GPP access mode includes at least one of a WLAN access mode or a Bluetooth access mode.

In some embodiments, the identifier of the remote terminal in the session report is the SUCI.

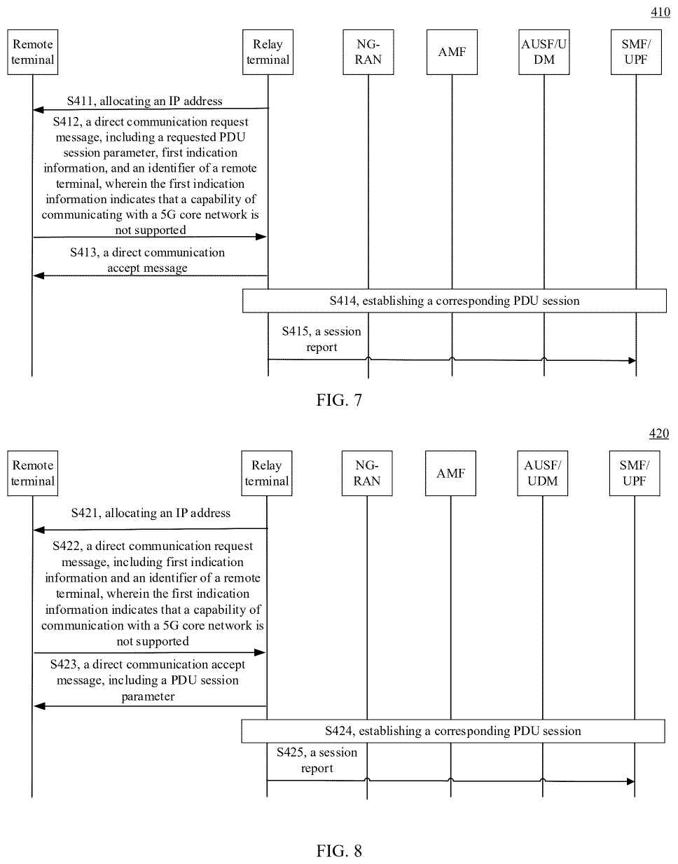

The preferred embodiments of the present disclosure are exemplarily illustrated hereinafter with reference to FIGS. 7 to 10.

### First Embodiments

In the embodiments, a remote terminal transmits a direct communication request message to a relay terminal over a connection established between the remote terminal and the relay terminal based on a non-3GPP access mode; and the remote terminal receives a direct communication accept message from the relay terminal. The direct communication request message includes a requested PDU session parameter, first indication information, and an identifier of the remote terminal, wherein the first indication information indicates that the remote terminal does not have a capability of communicating with a 5G core network.

FIG. 7 is a schematic flowchart of a method 410 for wireless communication according to some embodiments of the present disclosure.

As illustrated in FIG. 7, the method 410 includes the following processes.

In S411, a relay terminal allocates an IP address to a remote terminal.

Exemplarily, a remote terminal accesses a relay terminal in a WLAN mode, and after accessing the relay terminal, the remote terminal acquires an IP address allocated by the relay terminal to the remote terminal. The relay terminal is a terminal device having a WLAN AP function and a relay function.

In S412, the remote terminal transmits a direct communication request message to the relay terminal, wherein the direct communication request message includes a requested PDU session parameter, first indication information, and an identifier of the remote terminal, wherein first indication information indicates that the remote terminal does not have a capability of communicating with a 5G core network.

Exemplarily, the remote terminal transmits, on a PDU layer, the direct communication request message to the relay terminal.

Correspondingly, the relay terminal receives, on the PDU layer, the direct communication request message from the remote terminal. In some embodiments, the PDU layer includes an IP layer. In some embodiments, the direct communication request message is also referred to as a PC5 message.

It should be noted that, in the case that a PC5 connection is established in an NR-based access mode, the remote terminal allocates a source L2 ID, and transmits, based on a destination L2 ID acquired in a relay discovery process, a direct communication request message. In the embodiments, the terminal device establishes the PC5 connection based on a WLAN access mode, and since the commercial investment and cost of the WLAN access mode are lower than those of the NR-based access mode, and the use of a proprietary frequency band is not required, not only the connection of the remote terminal with a 5G network via the relay terminal is realized, but also the limitations in the connection between the remote terminal and the relay terminal is reduced, such that the development difficulty is reduced and the development cycle is shortened.

In the embodiments, since the first indication information indicates that the remote terminal does not have a capability of communicating with a 5G core network, an identifier of the remote terminal is an identifier in an NAI format. The NAI format is expressed as the format username@realm, and the NAI format is a subscriber identity identifier defined by the home network operator and is globally unique.

Exemplarily, the case that the remote terminal does not have a capability of communicating with a 5G core network includes, but is not limited to: the case that the remote terminal does not have a capability of safe communication with a 5G core network or the case that the remote terminal does not have an authentication capability when communicating with a 5G core network.

Exemplarily, the first indication information indicates, over an information element, whether the remote terminal has a capability of communicating with a 5G core network. For example, the value of one bit in the information element is used for indicating whether the remote terminal has a capability of communicating with a 5G core network. For example, in the case that the value of the one bit is a first numerical value, it indicates that the remote terminal has a capability of communicating with a 5G core network, and in the case that the value of the one bit is a second numerical value, it indicates that the remote terminal does not have a capability of communicating with a 5G core network. In some embodiments, the first numerical value is 0 and the second numerical value is 1, and in some embodiments, the first numerical value is 1 and the second numerical value is 0.

In the embodiments, the direct communication request message includes a PDU session parameter requested by the remote terminal. That is, the remote terminal indicates, using the direct communication request message, a PDU session parameter requested by the remote terminal to the relay terminal. Correspondingly, the relay terminal, after receiving the direct communication request message, establishes a PDU session based on the PDU session parameter in the direct communication request message.

Exemplarily, the requested PDU session parameter includes at least one of: a DNN, S-NSSAI, an SSC mode, or a type of a PDU session. The type of the PDU session includes, but is not limited to: IPv4, IPV6, IPv4v6, Ethernet, or Unstructured.

In S413, the remote terminal receives a direct communication accept message from the relay terminal.

In S414, the relay terminal establishes a corresponding PDU session.

In S415, the relay terminal transmits a session report to an SMF or a UPF.

Exemplarily, the session report is used for reporting parameters related to the remote terminal. For example, the session report includes at least one of: an identifier of a PDU session, an identifier of the remote terminal, or a non-3GPP access mode used by the remote terminal to access the relay terminal.

Exemplarily, since the first indication information indicates that the remote terminal does not have a capability of communicating with a 5G core network, an identifier of the remote terminal in the direct communication request message is in an NAI format, and in this case, the relay terminal generates, based on the identifier in the NAI format, an SUCI of the remote terminal, and reports the SUCI of the remote terminal to the SMF or the UPF by carrying the SUCI in the session report.

Exemplarily, a non-3GPP access mode of the session report is a WLAN access mode.

In addition, in some embodiments, in the case that the remote terminal accesses the relay terminal in a Bluetooth mode in S411, a non-3GPP access mode of the session report is the Bluetooth access mode, which is not specifically limited in the embodiments.

In the embodiments, by transmitting a session report to the SMF or the UPF, not only the control effect of the network on the remote terminal is improved, but also the resource utilization rate is improved. For example, in an actual use process, in the case that an intelligent terminal (e.g., a mobile phone) is used as a hotspot, and then a laptop computer or other mobile phones is connected to the internet via the intelligent terminal used as the hotspot, the intelligent terminal used as the hotspot reports a session report of the laptop computer or other mobile phones to an operator network, which is beneficial to improving the control of the operator network over the laptop computer or other mobile phones via the intelligent terminal, and in addition, is also beneficial to the operator to perceive the existence of the laptop computer or other mobile phones via the intelligent terminal, such that the abuse of network resources is avoided and the resource utilization rate is further improved.

### Second Embodiments

In the embodiments, a remote terminal transmits a direct communication request message to a relay terminal over a connection established between the remote terminal and the relay terminal based on a non-3GPP access mode; and the remote terminal receives a direct communication accept message from the relay terminal. The direct communication request message includes first indication information and an identifier of the remote terminal. The first indication information indicates that the remote terminal does not have a capability of communicating with a 5G core network. The direct communication accept message includes a PDU session parameter corresponding to the PDU session established by the relay terminal or a PDU session parameter supported by the relay terminal.

FIG. 8 is a schematic flowchart of a method 420 for wireless communication according to some embodiments of the present disclosure.

As illustrated in FIG. 8, the method 420 includes the following processes.

In S421, a relay terminal allocates an IP address to a remote terminal.

Exemplarily, a remote terminal accesses a relay terminal in a WLAN mode, and after accessing the relay terminal, the remote terminal acquires an IP address allocated by the relay terminal to the remote terminal. The relay terminal is a terminal device having a WLAN AP function and a relay function.

In S422, the remote terminal transmits a direct communication request message to the relay terminal, wherein the direct communication request message includes first indication information and an identifier of the remote terminal, wherein the first indication information indicates that the remote terminal does not have a capability of communicating with a 5G core network.

Exemplarily, the remote terminal transmits, on a PDU layer, the direct communication request message to the relay terminal.

Correspondingly, the relay terminal receives, on the PDU layer, the direct communication request message from the remote terminal. In some embodiments, the PDU layer includes an IP layer. In some embodiments, the direct communication request message is also referred to as a PC5 message.

It should be noted that, in the case that a PC5 connection is established in an NR-based access mode, the remote terminal allocates a source L2 ID, and transmits, based on a destination L2 ID acquired in a relay discovery process, a direct communication request message. In the embodiments, the terminal device establishes a PC5 connection based on a WLAN access mode, and since the commercial investment and cost of the WLAN access mode are lower than those of the NR-based access mode, and the use of a proprietary frequency band is not required, not only the connection of the remote terminal with a 5G network via the relay terminal is realized, but also the limitations in the connection between the remote terminal and the relay terminal is reduced, such that the development difficulty is reduced and the development cycle is shortened.

In the embodiments, since the first indication information indicates that the remote terminal does not have a capability of communicating with a 5G core network, an identifier of the remote terminal is an identifier in an NAI format. The NAI format is expressed as the format username@realm, and the NAI format is a subscriber identity identifier defined by the home network operator and is globally unique.

Exemplarily, the case that the remote terminal does not have a capability of communicating with a 5G core network includes, but is not limited to: the case that the remote terminal does not have a capability of safe communication with a 5G core network or the case that the remote terminal does not have an authentication capability when communicating with a 5G core network.

Exemplarily, the first indication information indicates, over an information element, whether the remote terminal has a capability of communicating with a 5G core network. For example, the value of one bit in the information clement is used for indicating whether the remote terminal has a capability of communicating with a 5G core network. For example, in the case that the value of the one bit is a first numerical value, it indicates that the remote terminal has a capability of communicating with a 5G core network, and in the case that the value of the one bit is a second numerical value, it indicates that the remote terminal does not have a capability of communicating with a 5G core network. In some embodiments, the first numerical value is 0 and the second numerical value is 1, and in some embodiments, the first numerical value is 1 and the second numerical value is 0.

In S423, the remote terminal receives a direct communication accept message from the relay terminal, wherein the direct communication accept message includes a PDU session parameter.

Exemplarily, the direct communication accept message includes a PDU session parameter corresponding to the PDU session established by the relay terminal, or the direct communication accept message includes a PDU session parameter supported by the relay terminal. In other words, the remote terminal does not need to indicate the PDU session parameter requested by the remote terminal to the relay terminal, that is, the relay terminal may directly use the established PDU session or establish a PDU session using the PDU session parameter supported by the relay terminal, and notify the remote terminal that the PDU session parameter used by the relay terminal is the PDU session parameter corresponding to the established PDU session or the PDU session parameter supported by the relay terminal.

Exemplarily, the PDU session parameter includes at least one of: a DNN, S-NSSAI, an SSC mode, or a type of a PDU session. The type of the PDU session includes, but is not limited to: IPv4, IPv6, IPv4v6, Ethernet, or Unstructured.

In S424, the relay terminal establishes a corresponding PDU session.

Exemplarily, the PDU session established by the relay terminal is a PDU session established before S422, and in this case, the PDU session parameter in S423 is a PDU session parameter corresponding to the PDU session established by the relay terminal. Exemplarily, the PDU session established by the relay terminal is a PDU session established before S422, and in this case, the PDU session parameter in S423 is a PDU session parameter supported by the relay terminal.

In S425, the relay terminal transmits a session report to an SMF or a UPF.

Exemplarily, the session report is used for reporting parameters related to the remote terminal. For example, the session report includes at least one of: an identifier of a PDU session, an identifier of the remote terminal, or a non-3GPP access mode used by the remote terminal to access the relay terminal.

Exemplarily, since the first indication information indicates that the remote terminal does not have a capability of communicating with a 5G core network, an identifier of the remote terminal in the direct communication request message is in an NAI format, and in this case, the relay terminal generates, based on the identifier in the NAI format, an SUCI of the remote terminal, and reports the SUCI of the remote terminal to the SMF or the UPF by carrying the SUCI in the session report.

Exemplarily, a non-3GPP access mode of the session report is a WLAN access mode.

In addition, in some embodiments, in the case that the remote terminal accesses the relay terminal in a Bluetooth mode in S421, a non-3GPP access mode of the session report is a Bluetooth access mode, which is not specifically limited in the embodiments.

In the embodiments, by transmitting a session report to the SMF or the UPF, not only the control effect of the network on the remote terminal is improved, but also the resource utilization rate is improved. For example, in an actual use process, in the case that an intelligent terminal (e.g., a mobile phone) is used as a hotspot, and then a laptop computer or other mobile phones is connected to the internet via the intelligent terminal used as the hotspot, the intelligent terminal used as the hotspot reports a session report of the laptop computer or other mobile phones to an operator network, which is beneficial to improving the control of the operator network over the laptop computer or other mobile phones via the intelligent terminal, and in addition, is also beneficial to the operator to perceive the existence of the laptop computer or other mobile phones via the intelligent terminal, such that the abuse of network resources is avoided and the resource utilization rate is further improved.

### Third Embodiments

In the embodiments, a remote terminal transmits a direct communication request message to a relay terminal over a connection established between the remote terminal and the relay terminal based on a non-3GPP access mode; and the remote terminal receives a direct communication accept message from the relay terminal. The direct communication request message includes a requested PDU session parameter, first indication information, and an identifier of the remote terminal, wherein the first indication information indicates that the remote terminal has a capability of communicating with a 5G core network.

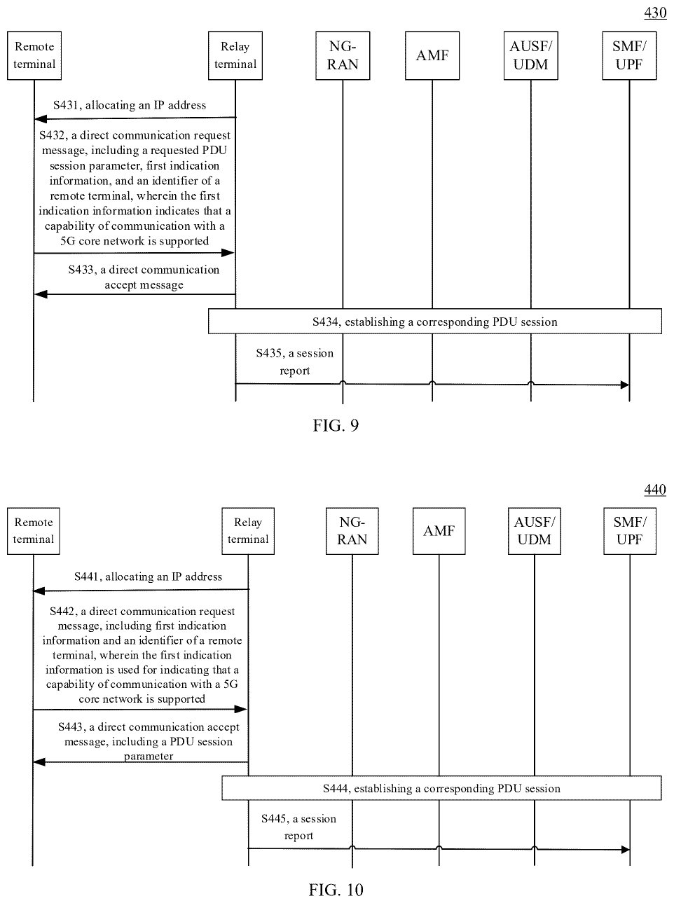

FIG. 9 is a schematic flowchart of a method 430 for wireless communication according to some embodiments of the present disclosure.

As illustrated in FIG. 9, the method 430 includes the following processes.

In S431, a relay terminal allocates an IP address to a remote terminal.

Exemplarily, a remote terminal accesses a relay terminal in a WLAN mode, and after accessing the relay terminal, the remote terminal acquires an IP address allocated by the relay terminal to the remote terminal. The relay terminal is a terminal device having a WLAN AP function and a relay function.

In S432, the remote terminal transmits a direct communication request message to the relay terminal, wherein the direct communication request message includes a requested PDU session parameter, first indication information, and an identifier of the remote terminal, wherein the first indication information indicates that the remote terminal has a capability of communicating with a 5G core network.

Exemplarily, the remote terminal transmits, on a PDU layer, the direct communication request message to the relay terminal.

Correspondingly, the relay terminal receives, on the PDU layer, the direct communication request message from the remote terminal. In some embodiments, the PDU layer includes an IP layer. In some embodiments, the direct communication request message is also referred to as a PC5 message.

It should be noted that, in the case that a PC5 connection is established in an NR-based access mode, the remote terminal allocates a source L2 ID, and transmits, based on a destination L2 ID acquired in a relay discovery process, a direct communication request message. In the embodiments, the terminal device establishes a PC5 connection based on a WLAN access mode, and since the commercial investment and cost of the WLAN access mode are lower than those of the NR-based access mode, and the use of a proprietary frequency band is not required, not only the connection of the remote terminal with a 5G network via the relay terminal is realized, but also the limitations in the connection between the remote terminal and the relay terminal is reduced, such that the development difficulty is reduced and the development cycle is shortened.

In the embodiments, since the first indication information indicates that the remote terminal has a capability of communicating with a 5G core network, an identifier of the remote terminal is an SUCI.

Exemplarily, the case that the remote terminal has a capability of communicating with a 5G core network includes, but is not limited to: the case that the remote terminal has a capability of safe communication with a 5G core network or the case that the remote terminal has an authentication capability when communicating with a 5G core network.

Exemplarily, the first indication information indicates, over an information element, whether the remote terminal has a capability of communicating with a 5G core network. For example, the value of one bit in the information element is used for indicating whether the remote terminal has a capability of communicating with a 5G core network. For example, in the case that the value of the one bit is a first numerical value, it indicates that the remote terminal has a capability of communicating with a 5G core network, and in the case that the value of the one bit is a second numerical value, it indicates that the remote terminal does not have a capability of communicating with a 5G core network. In some embodiments, the first numerical value is 0 and the second numerical value is 1, and in some embodiments, the first numerical value is 1 and the second numerical value is 0.

In the embodiments, the direct communication request message includes a PDU session parameter requested by the remote terminal. That is, the remote terminal indicates, using the direct communication request message, a PDU session parameter requested by the remote terminal to the relay terminal. Correspondingly, the relay terminal, after receiving the direct communication request message, establishes a PDU session based on the PDU session parameter in the direct communication request message.

Exemplarily, the requested PDU session parameter includes at least one of: a DNN, S-NSSAI, an SSC mode, or a type of a PDU session. The type of the PDU session includes, but is not limited to: IPv4, IPv6, IPv4v6, Ethernet, or Unstructured.

In S433, the remote terminal receives a direct communication accept message from the relay terminal.

In S434, the relay terminal establishes a corresponding PDU session.

In S435, the relay terminal transmits a session report to an SMF or a UPF.

Exemplarily, the session report is used for reporting parameters related to the remote terminal. For example, the session report includes at least one of: an identifier of a PDU session, an identifier of the remote terminal, or a non-3GPP access mode used by the remote terminal to access the relay terminal.

Exemplarily, since the first indication information indicates that the remote terminal has a capability of communicating with a 5G core network, an identifier of the remote terminal in the direct communication request message is an SUCI, and in this case, the relay terminal directly reports the SUCI to the SMF or the UPF by carrying the SUCI in the session report.

Exemplarily, a non-3GPP access mode of the session report is a WLAN access mode.

In addition, in alternative embodiments, in the case that the remote terminal accesses the relay terminal in a Bluetooth mode in S431, a non-3GPP access mode of the session report is a Bluetooth access mode, which is not specifically limited in the embodiments.

In the embodiments, by transmitting a session report to the SMF or the UPF, not only the control effect of the network on the remote terminal is improved, but also the resource utilization rate is improved. For example, in an actual use process, in the case that an intelligent terminal (e.g., a mobile phone) is used as a hotspot, and then a laptop computer or other mobile phones is connected to the internet via the intelligent terminal used as the hotspot, the intelligent terminal used as the hotspot reports a session report of the laptop computer or other mobile phones to an operator network, which is beneficial to improving the control of the operator network over the laptop computer or other mobile phones via the intelligent terminal, and in addition, is also beneficial to the operator to perceive the existence of the laptop computer or other mobile phones via the intelligent terminal, such that the abuse of network resources is avoided and the resource utilization rate is further improved.

### Fourth Embodiments

In the embodiments, a remote terminal transmits a direct communication request message to a relay terminal over a connection established between the remote terminal and the relay terminal based on a non-3GPP access mode; and the remote terminal receives a direct communication accept message from the relay terminal. The direct communication request message includes first indication information and an identifier of the remote terminal, wherein the first indication information indicates that the remote terminal has a capability of communicating with a 5G core network; and the direct communication accept message includes a PDU session parameter corresponding to the PDU session established by the relay terminal or a PDU session parameter supported by the relay terminal.

FIG. 10 is a schematic flowchart of a method 440 for wireless communication according to some embodiments of the present disclosure.

As illustrated in FIG. 10, the method 440 includes:

In S441, a relay terminal allocates an IP address to a remote terminal.

Exemplarily, a remote terminal accesses a relay terminal in a WLAN mode, and after accessing the relay terminal, the remote terminal acquires an IP address allocated by the relay terminal to the remote terminal. The relay terminal is a terminal device having a WLAN AP function and a relay function.

In S442, the remote terminal transmits a direct communication request message to the relay terminal, wherein the direct communication request message includes first indication information and an identifier of the remote terminal, wherein the first indication information indicates that the remote terminal has a capability of communicating with a 5G core network.

Exemplarily, the remote terminal transmits, on a PDU layer, the direct communication request message to the relay terminal.

Correspondingly, the relay terminal receives, on the PDU layer, the direct communication request message from the remote terminal. In some embodiments, the PDU layer includes an IP layer. In some embodiments, the direct communication request message is also referred to as a PC5 message.

It should be noted that, in the case that a PC5 connection is established in an NR-based access mode, the remote terminal allocates a source L2 ID, and transmits, based on a destination L2 ID acquired in a relay discovery process, a direct communication request message. In the embodiments, the terminal device establishes a PC5 connection based on a WLAN access mode, and since the commercial investment and cost of the WLAN access mode are lower than those of the NR-based access mode, and the use of a proprietary frequency band is not required, not only the connection of the remote terminal with a 5G network via the relay terminal is realized, but also the limitations in the connection between the remote terminal and the relay terminal is reduced, such that the development difficulty is reduced and the development cycle is shortened.

In the embodiments, since the first indication information indicates that the remote terminal has a capability of communicating with a 5G core network, an identifier of the remote terminal is an SUCI.

Exemplarily, the case that the remote terminal has a capability of communicating with a 5G core network includes, but is not limited to: the case that the remote terminal has a capability of safe communication with a 5G core network or the case that the remote terminal has an authentication capability when communicating with a 5G core network.

Exemplarily, the first indication information indicates, over an information element, whether the remote terminal has a capability of communicating with a 5G core network. For example, the value of one bit in the information element is used for indicating whether the remote terminal has a capability of communicating with a 5G core network. For example, in the case that the value of the one bit is a first numerical value, it indicates that the remote terminal has a capability of communicating with a 5G core network, and in the case that the value of the one bit is a second numerical value, it indicates that the remote terminal does not have a capability of communicating with a 5G core network. In some embodiments, the first numerical value is 0 and the second numerical value is 1, and in some embodiments, the first numerical value is 1 and the second numerical value is 0.

In S443, the remote terminal receives a direct communication accept message from the relay terminal, wherein the direct communication accept message includes a PDU session parameter.

Exemplarily, the direct communication accept message includes a PDU session parameter corresponding to the PDU session established by the relay terminal, or the direct communication accept message includes a PDU session parameter supported by the relay terminal. In other words, the remote terminal does not need to indicate the PDU session parameter requested by the remote terminal to the relay terminal, that is, the relay terminal may directly use the established PDU session or establish a PDU session using the PDU session parameter supported by the relay terminal, and notify the remote terminal that the PDU session parameter used by the relay terminal is the PDU session parameter corresponding to the established PDU session or the PDU session parameter supported by the relay terminal.

Exemplarily, the PDU session parameter includes at least one of: a DNN, S-NSSAI, an SSC mode, or a type of a PDU session. The type of the PDU session includes, but is not limited to: IPv4, IPv6, IPv4v6, Ethernet, or Unstructured.

In S444, the relay terminal establishes a corresponding PDU session.

Exemplarily, the PDU session established by the relay terminal is a PDU session established before S442, and in this case, the PDU session parameter in S443 is a PDU session parameter corresponding to the PDU session established by the relay terminal. Exemplarily, the PDU session established by the relay terminal is a PDU session established before S442, and in this case, the PDU session parameter in S443 is a PDU session parameter supported by the relay terminal.

In S445, the relay terminal transmits a session report to an SMF or a UPF.

Exemplarily, the session report is used for reporting parameters related to the remote terminal. For example, the session report includes at least one of: an identifier of a PDU session, an identifier of the remote terminal, or a non-3GPP access mode used by the remote terminal to access the relay terminal.

Exemplarily, since the first indication information indicates that the remote terminal does not have a capability of communicating with a 5G core network, an identifier of the remote terminal in the direct communication request message is in an NAI format, and in this case, the relay terminal generates, based on the identifier in the NAI format, an SUCI of the remote terminal, and reports the SUCI of the remote terminal to the SMF or the UPF by carrying the SUCI in the session report.

Exemplarily, a non-3GPP access mode of the session report is a WLAN access mode.

In addition, in some embodiments, in the case that the remote terminal accesses the relay terminal in a Bluetooth mode in S441, a non-3GPP access mode of the session report is a Bluetooth access mode, which is not specifically limited in the embodiments.

In the embodiments, by transmitting a session report to the SMF or the UPF, not only the control effect of the network on the remote terminal is improved, but also the resource utilization rate is improved. For example, in an actual use process, in the case that an intelligent terminal (e.g., a mobile phone) is used as a hotspot, and then a laptop computer or other mobile phones is connected to the internet via the intelligent terminal used as the hotspot, the intelligent terminal used as the hotspot reports a session report of the laptop computer or other mobile phones to an operator network, which is beneficial to improving the control of the operator network over the laptop computer or other mobile phones via the intelligent terminal, and in addition, is also beneficial to the operator to perceive the existence of the laptop computer or other mobile phones via the intelligent terminal, such that the abuse of network resources is avoided and the resource utilization rate is further improved.

The preferred embodiments of the present disclosure have been described in detail in conjunction with the accompanying drawings. However, the present disclosure is not limited to the specific details of the above embodiments, and various simple modifications may be made to the technical solutions according to the present disclosure within the scope of the technical conception of the present disclosure, and these simple modifications all fall within the protection scope of the present disclosure. For example, the various specific technical features described in the above specific embodiments may be combined in any suitable manner without contradiction, and various possible combinations are not explained in the present disclosure in order to avoid unnecessary repetition. For example, various embodiments of the present disclosure may be combined arbitrarily and should be considered as the contents disclosed in the present disclosure as long as they do not violate the concept of the present disclosure.

It should be further understood that in the various method embodiments of the present disclosure, the serial numbers of the above-mentioned processes do not imply the execution sequence. The execution sequence among these processes should be determined by their functions and internal logic, and should not impose any limitation on the implementation of the embodiments of the present disclosure.

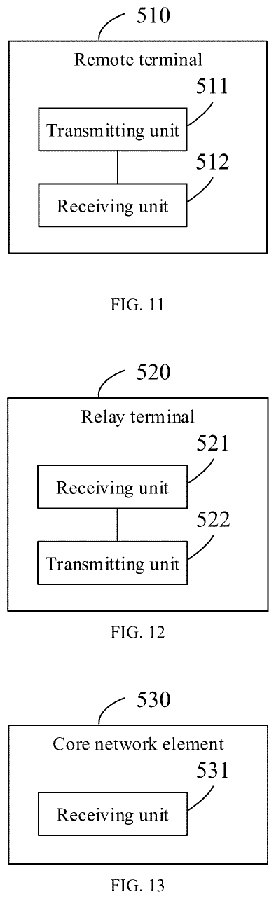

The method embodiments of the present disclosure have been described in detail above with reference to FIGS. 5 to 10, and the apparatus embodiments of the present disclosure are described in detail hereinafter with reference to FIGS. 11 to 15.

FIG. 11 is a schematic block diagram of a remote terminal 510 according to some embodiments of the present disclosure.

As illustrated in FIG. 11, the remote terminal 510 includes:
a transmitting unit 511, configured to transmit a direct communication request message to a relay terminal over a connection established between the remote terminal and the relay terminal based on a non-3GPP access mode; and
a receiving unit 512, configured to receive a direct communication accept message from the relay terminal.

In some embodiments, the direct communication request message includes first indication information and/or an identifier of the remote terminal, wherein the first indication information indicates whether the remote terminal has a capability of communicating with a 5G core network.

In some embodiments, in the case that the first indication information indicates that the remote terminal does not have the capability of communicating with a 5G core network, an identifier of the remote terminal is in an NAI format; in the case that the first indication information indicates that the remote terminal has the capability of communicating with a 5G core network, an identifier of the remote terminal is an SUCI.

In some embodiments, the direct communication request message includes a PDU session parameter requested by the remote terminal.

In some embodiments, the direct communication accept message includes a PDU session parameter corresponding to the PDU session established by the relay terminal, or the direct communication accept message includes a PDU session parameter supported by the relay terminal.

In some embodiments, the PDU session parameter includes at least one of: a DNN, S-NSSAI, an SSC mode, or a type of a PDU session.

In some embodiments, the receiving unit 512 is further configured to: acquire an IP address allocated by the relay terminal to the remote terminal in a process of establishing the connection between the remote terminal and the relay terminal based on the non-3GPP access mode.

In some embodiments, the transmitting unit 511 is specifically configured to: transmit, on a PDU layer, the direct communication request message to the relay terminal.

In some embodiments, the PDU layer includes an IP layer.

In some embodiments, the non-3GPP access mode includes at least one of a WLAN access mode or a Bluetooth access mode.

It should be understood that the apparatus embodiments may correspond to the method embodiments, and similar descriptions may refer to the method embodiments. Specifically, the remote terminal 510 illustrated in FIG. 11 corresponds to corresponding subject performing the methods according to the embodiments of the present disclosure, and the above and other operations and/or functions of the units in the remote terminal 510 are separately used for perform corresponding processes in the methods of the present disclosure, which are not repeated herein for brevity.

FIG. 12 is a schematic block diagram of a relay terminal 520 according to some embodiments of the present disclosure.

As illustrated in FIG. 12, the relay terminal 520 includes:
a receiving unit 521, configured to receive a direct communication request message from a remote terminal over a connection established between the remote terminal and the relay terminal based on a non-3GPP access mode; and
a transmitting unit 522, configured to transmit a direct communication accept message to the remote terminal.

In some embodiments, the direct communication request message includes first indication information and/or an identifier of the remote terminal, wherein the first indication information indicates whether the remote terminal has a capability of communicating with a 5G core network.

In some embodiments, in the case that the first indication information indicates that the remote terminal does not have the capability of communicating with a 5G core network, an identifier of the remote terminal is in an NAI format; in the case that the first indication information indicates that the remote terminal has the capability of communicating with a 5G core network, an identifier of the remote terminal is an SUCI.

In some embodiments, the direct communication request message includes a PDU session parameter requested by the remote terminal; and the receiving unit 521 is further configured to: establish a PDU session based on the PDU session parameter.

In some embodiments, the direct communication accept message includes a PDU session parameter corresponding to the PDU session established by the relay terminal, or the direct communication accept message includes a PDU session parameter supported by the relay terminal; and the receiving unit 521 is further configured to: establish a PDU session based on the PDU session parameter.

In some embodiments, the PDU session parameter includes at least one of: a DNN, S-NSSAI, an SSC mode, or a type of a PDU session.

In some embodiments, the transmitting unit 522 is further configured to: allocate an IP address to the remote terminal in a process of establishing the connection between the remote terminal and the relay terminal based on the non-3GPP access mode.

In some embodiments, the receiving unit 521 is specifically configured to: receive, on a PDU layer, the direct communication request message from the remote terminal.

In some embodiments, the PDU layer includes an IP layer.

In some embodiments, the transmitting unit 522 is further configured to: transmit a session report to an SMF or a UPF.

The session report includes at least one of: an identifier of a PDU session, an identifier of the remote terminal, or a non-3GPP access mode used by the remote terminal to access the relay terminal.

In some embodiments, the non-3GPP access mode includes at least one of a WLAN access mode or a Bluetooth access mode.

In some embodiments, in the case that the direct communication request message includes an SUCI of the remote terminal, the session report includes the SUCI of the remote terminal.

In some embodiments, in the case that the direct communication request message includes an identifier in an NAI format of the remote terminal, the session report includes an SUCI generated by the relay terminal based on the identifier in the NAI format.

It should be understood that the apparatus embodiments may correspond to the method embodiments, and similar descriptions may refer to the method embodiments. Specifically, the relay terminal 520 illustrated in FIG. 12 corresponds to corresponding subject in the methods according to the embodiments of the present disclosure, and the above and other operations and/or functions of the units in the relay terminal 520 are separately used for performing corresponding processes in the methods of the present disclosure, which are not repeated herein for brevity.

FIG. 13 is a schematic block diagram of a core network element 530 according to some embodiments of the present disclosure.

As illustrated in FIG. 13, the core network element 530 includes:
a receiving unit 531, configured to receive a session report from a relay terminal.

The session report includes at least one of: an identifier of a PDU session, an identifier of a remote terminal, or a non-3GPP access mode used by the remote terminal to access the relay terminal.

In some embodiments, the non-3GPP access mode includes at least one of a WLAN access mode or a Bluetooth access mode.

In some embodiments, the identifier of the remote terminal in the session report is an SUCI.

In some embodiments, the core network clement 530 is an SMF or a UPF.

It should be understood that the apparatus embodiments may correspond to the method embodiments, and similar descriptions may refer to the method embodiments. Specifically, the core network element 530 illustrated in FIG. 13 corresponds to corresponding subject in the methods according to the embodiments of the present disclosure, and the above and other operations and/or functions of the units in the core network element 530 are used for performing corresponding processes in the methods of the present disclosure, which are not repeated herein for brevity.

The communication device in the embodiments of the present disclosure is described above from the perspective of functional modules in conjunction with the accompanying drawings. It should be understood that the functional modules may be implemented by hardware, by instructions in the form of software, or by a combination of hardware and software modules. Specifically, the processes in the method embodiments of the present disclosure may be performed by integrated logic circuits of hardware in a processor and/or instructions in the form of software, and may be directly embodied as being performed by a hardware decoding processor, or performed by a combination of hardware and software modules in a decoding processor. In some embodiments, the software module may be disposed in a random access memory (RAM), a flash memory, a read-only memory (ROM), a programmable ROM (PROM), an electrically erasable programmable memory, a register, or other mature storage medium in the art. The storage medium is disposed in a memory, and the processor reads information from the memory and performs the processes in the above method embodiments in conjunction with its hardware.

For example, the processing unit and the communication unit referred to above may be implemented by a processor and a transceiver, respectively.

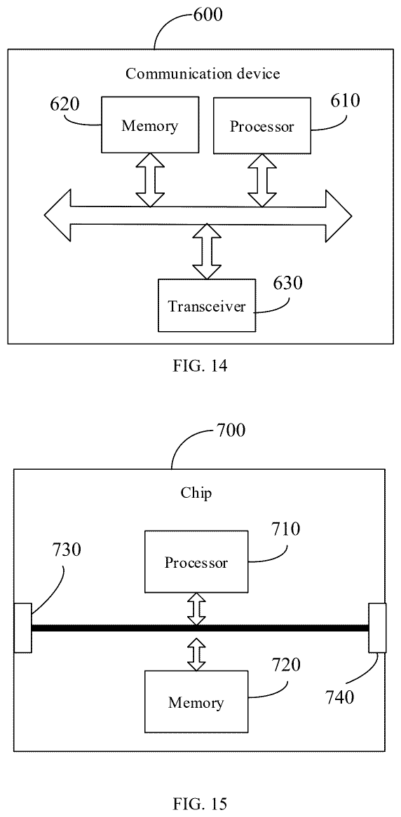

FIG. 14 is a schematic structural diagram of a communication device 600 according to some embodiments of the present disclosure.

As illustrated in FIG. 14, the communication device 600 includes a processor 610.

The processor 610 is configured to load and run one or more computer programs from the memory to perform the methods in the embodiments of the present disclosure.

As illustrated in FIG. 14, the communication device 600 further includes a memory 620.

The memory 620 is configured to store indication information, or is configured to store codes, instructions, or the like executed by the processor 610. The processor 610 is configured to load and run one or more computer programs from the memory 620 to perform the methods in the embodiments of the present disclosure. The memory 620 is a separate device independent from the processor 610 or is integrated within the processor 610.

As illustrated in FIG. 14, the communication device 600 further includes a transceiver 630.

The processor 610 controls the transceiver 630 to communicate with other devices, specifically, to transmit information or data to the other devices or receive information or data from other devices. The transceiver 630 includes a transmitter and a receiver. The transceiver 630 further includes one or more antennas.

It should be understood that the components in the communication device 600 are connected by a bus system. The bus system includes a power bus, a control bus, and a status signal bus in addition to a data bus.

It should also be understood that the communication device 600 may be a remote terminal, a relay terminal, or a core network element in the embodiments of the present disclosure, and the communication device 600 may perform corresponding processes performed by terminal devices in the methods according to the embodiments of the present disclosure. That is, the communication device 600 in the embodiments of the present disclosure may correspond to the remote terminal 510, the relay terminal 520, or the core network element 530 in the embodiments of the present disclosure, and may correspond to corresponding subject performing the methods according to the embodiments of the present disclosure, which are not repeated herein for brevity.

In addition, the embodiments of the present disclosure further provide a chip.

For example, the chip is an integrated circuit chip that has signal processing capabilities and implements or performs the methods, processes, and logic block diagrams disclosed in the embodiments of the present disclosure. The chip may also be referred to as a system-level chip, a system chip, a chip system, a system-on-a-chip, or the like. In some embodiments, the chip is applicable to various communication devices, such that the communication device equipped with the chip performs the methods, processes, and logic block diagrams disclosed in the embodiments of the present disclosure.

FIG. 15 is a schematic structural diagram of a chip 700 according to some embodiments of the present disclosure.

As illustrated in FIG. 15, the chip 700 includes a processor 710.

The processor 710 is configured to load and run one or more computer programs from the memory to perform the methods in the embodiments of the present disclosure.

As illustrated in FIG. 15, the chip 700 further includes a memory 720.

The processor 710 is configured to load and run one or more computer programs from the memory 720 to perform the methods in the embodiments of the present disclosure. The memory 720 is configured to store indication information, or is configured to store codes, instructions, or the like executed by the processor 710. The memory 720 is a separate device independent from the processor 710 or is integrated within the processor 710.

As illustrated in FIG. 15, the chip 700 further includes an input interface 730.

The processor 710 controls the input interface 730 to communicate with other devices or chips, specifically, to acquire information or data transmitted by other devices or chips.

As illustrated in FIG. 15, the chip 700 further includes an output interface 740.

The processor 710 controls the output interface 740 to communicate with other devices or chips, specifically, to output information or data to other devices or chips.

It should be understood that the chip 700 may be applicable to the remote terminal, the relay terminal, or the core network element in the embodiments of the present disclosure, and the chip may implement a corresponding flow implemented by the remote terminal, the relay terminal, or the core network element in the methods of the embodiments of the present disclosure, which are not repeated herein for brevity. It should also be understood that the components in the chip 700 are connected by a bus system. The bus system includes a power bus, a control bus, and a status signal bus in addition to a data bus.

The processor referred to above may include, but is not limited to: a general-purpose processor, a digital signal processor (DSP), an application specific integrated circuit (ASIC), a field programmable gate array (FPGA), or another programmable logic device, a discrete gate or transistor logic device, a discrete hardware component, or the like.

The processor may be configured to implement or perform the methods, processes, and logic block diagrams disclosed in the embodiments of the present disclosure. The processes of the methods disclosed in the embodiments of the present disclosure may be directly embodied as being performed by a hardware decoding processor or being performed by a combination of hardware and software modules within the decoding processor. The software module may be disposed in a RAM, a flash memory, a ROM, a PROM, an erasable programmable memory, a register, or other mature storage medium in the art. The storage medium is disposed in a memory, and the processor reads information from the memory and performs the processes of the above methods in combination with its hardware.

The memory referred to above includes, but is not limited to: a volatile memory and/or a non-volatile memory. The non-volatile memory may be a ROM, a PROM, an erasable PROM (EPROM), an electrically EPROM (EEPROM), or flash memory. The volatile memory may be a RAM which serves as an external cache. By way of example but not limitation, many forms of RAMs may be applied, such as a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), and a direct rambus RAM (DR RAM).

It should be noted that the memory described herein is intended to include these and any other suitable types of memory.

Some embodiments of the present disclosure further provide a computer-readable storage medium. The computer-readable storage medium is configured to store one or more computer programs. The computer-readable storage medium stores one or more programs. The one or more programs include one or more instructions. The instructions, when loaded and executed by a portable electronic device including a plurality of application programs, cause the portable electronic device to perform the method for wireless communication in the present disclosure. In some embodiments, the computer-readable storage medium is applicable to the remote terminal, the relay terminal, or the core network element in the embodiments of the present disclosure, and the one or more computer programs cause a computer to perform corresponding processes performed by the remote terminal, the relay terminal, or the core network element in the methods according to the embodiments of the present disclosure, which are not repeated herein for brevity.

Some embodiments of the present disclosure further provide a computer program product. The computer program product includes one or more computer programs. In some embodiments, the computer program product is applicable to the remote terminal, the relay terminal, or the core network element in the embodiments of the present disclosure, and the one or more computer programs cause a computer to perform corresponding processes performed by the remote terminal, the relay terminal, or the core network element in the methods according to the embodiments of the present disclosure, which are not repeated herein for brevity.

Some embodiments of the present disclosure further provide a computer program. The computer program, when loaded and run by a computer, causes the computer to perform the method for wireless communication according to the present disclosure. In some embodiments, the computer program is applicable to the remote terminal, the relay terminal, or the core network clement in the embodiments of the present disclosure, and when run on a computer, causes the computer to perform a corresponding process performed by the remote terminal, the relay terminal, or the core network element in the methods according to the embodiments of the present disclosure, which are not repeated herein for brevity.

Some embodiments of the present disclosure further provide a communication system. The communication system may include the terminal device and the network device described above to form the communication system as illustrated in FIG. 1 or FIG. 2, which is not repeated herein for brevity. It should be noted that the term “system” or the like herein may also be referred to as a “network management architecture”, “network system”, or the like.

It should also be understood that the terms used in the embodiments of the present disclosure and the appended claims are for the purpose of describing specific embodiments only, and are not intended to limit the embodiments of the present disclosure. For example, the article “a,” “an,” “the,” “above,” and “this” used in the present disclosure and the appended claims arc intended to include the plural forms as well, unless the context clearly indicates otherwise.

It should be understood by those of ordinary skill in the art that the units and algorithm processes of various examples described in conjunction with the embodiments herein may be implemented in electronic hardware, or a combination of computer software and electronic hardware. Whether these functions are implemented in hardware or software depends on the specific application and design constraints of the technical solutions. Those skilled in the art may implement the described functions in varying ways for each specific application, but such implementations are not to be interpreted as departing from the scope of the embodiments of the present disclosure. The functions may be stored in a computer-readable storage medium in the case that they are implemented in the form of software functional units and sold or used as independent products. Based on such understandings, the technical solutions according to the embodiments of the present disclosure substantially, or the part thereof that contributes to the prior art, or part of the technical solutions, may be embodied in the form of a software product. The computer software product is stored in a storage medium and includes several instructions for causing a computer device (which may be a personal computer, a server, a network device, or the like) to perform all or part of the processes of the methods described in the embodiments of the present disclosure. The above storage medium includes various medium capable of storing program codes, such as a U-disk, a mobile hard disk, a ROM, a RAM, a magnetic disk, and an optical disk.

It should be understood by those skilled in the art that for convenience and brevity in description, the specific working processes of the systems, apparatuses, and units described above may refer to the corresponding processes in the above method embodiments, which are not repeated herein. In the several embodiments provided in the present disclosure, it should be understood that the disclosed systems, apparatuses, and methods may be implemented in other ways. For example, the division of the units or modules or components in the apparatus embodiments described above is only a logical functional division, and may be other division in actual implementation. For example, multiple units or modules or components may be combined or integrated into another system, or some units or modules or components may be omitted, or not executed. For example, the units/modules/components described above as separate/display components may or may not be physically separate, that is, they may be disposed in one place or distributed over a plurality of network elements. Some or all of the units/modules/components may be selected according to actual needs to achieve the purpose of the embodiments of the present disclosure. Finally, it should be noted that the coupling, direct coupling, or communication connection between each other that is illustrated or discussed above may be indirect coupling or communication connection via some interfaces, apparatuses, or units, and may be in electrical, mechanical, or other forms.

Described above are only specific embodiments of the present disclosure, but the protection scope of the embodiments of the present disclosure is not limited to these. Any variations or substitutions readily derived by those skilled in the art within the technical scope disclosed in the present disclosure shall fall within the protection scope of the embodiments of the present disclosure. Therefore. the protection scope of the embodiments of the present disclosure shall be subject to the protection scope of the claims.

1-37. (canceled)

38. A method for wireless communication, applicable to a relay terminal, the method comprising:
transmitting a session report to a core network element;
wherein the session report comprises at least one of: an identifier of a protocol data unit (PDU) session, an identifier of a remote terminal, or a non-3^{rd} Generation Partnership Project (3GPP) access mode used by the remote terminal to access the relay terminal.

39. The method according to claim 38, wherein the non-3GPP access mode comprises at least one of a wireless local area network (WLAN) access mode or a Bluetooth access mode.

40. The method according to claim 38, wherein the identifier of the remote terminal in the session report is a subscriber concealed identifier (SUCI).

41. The method according to claim 38, wherein the core network element comprises a session management function (SMF) or a user plane function (UPF).

42. A relay terminal, comprising:
a processor and a memory, wherein the memory is configured to store one or more computer programs, wherein the processor is configured to load and run the one or more computer programs stored in the memory, to cause the relay terminal to perform:
transmitting a session report to a core network element;
wherein the session report comprises at least one of: an identifier of a protocol data unit (PDU) session, an identifier of a remote terminal, or a non-3^{rd} Generation Partnership Project (3GPP) access mode used by the remote terminal to access the relay terminal.

43. The relay terminal according to claim 42, wherein the non-3GPP access mode comprises at least one of a wireless local area network (WLAN) access mode or a Bluetooth access mode.

44. The relay terminal according to claim 42, wherein the identifier of the remote terminal in the session report is a subscriber concealed identifier (SUCI).

45. The relay terminal according to claim 42, wherein the core network element comprises a session management function (SMF) or a user plane function (UPF).

46. The relay terminal according to claim 42, wherein the processor is configured to load and run the one or more computer programs stored in the memory, to cause the relay terminal to further perform:
receiving a direct communication request message from the remote terminal over a connection established between the remote terminal and the relay terminal based on a non-3GPP access mode; and
transmitting a direct communication accept message to the remote terminal.

47. The relay terminal according to claim 46, wherein the direct communication request message comprises first indication information and/or an identifier of the remote terminal, wherein the first indication information indicates whether the remote terminal has a capability of communicating with a 5^{th} generation (5G) core network.

48. The relay terminal according to claim 47, wherein in a case that the first indication information indicates that the remote terminal does not have the capability of communicating with the 5G core network, the identifier of the remote terminal is in a network access identifier (NAI) format; or in a case that the first indication information indicates that the remote terminal has the capability of communicating with the 5G core network, the identifier of the remote terminal is a subscriber concealed identifier (SUCI).

49. The relay terminal according to claim 46, wherein the direct communication request message comprises a PDU session parameter requested by the remote terminal; and the processor is configured to load and run the one or more computer programs stored in the memory, to cause the relay terminal to further perform:
establishing a PDU session based on the PDU session parameter.

50. The relay terminal according to claim 46, wherein the direct communication accept message comprises a PDU session parameter corresponding to a PDU session established by the relay terminal, or the direct communication accept message comprises a PDU session parameter supported by the relay terminal; and the processor is configured to load and run the one or more computer programs stored in the memory, to cause the relay terminal to further perform:
establishing a PDU session based on the PDU session parameter.

51. The relay terminal according to claim 49, wherein the PDU session parameter comprises at least one of: a data network name (DNN), single-network slice selection assistance information (S-NSSAI), a session and service continuity (SSC) mode, or a type of a PDU session.

52. The relay terminal according to claim 46, wherein the processor is configured to load and run the one or more computer programs stored in the memory, to cause the relay terminal to further perform:
allocating an Internet Protocol (IP) address to the remote terminal during establishment of the connection between the remote terminal and the relay terminal based on the non-3GPP access mode.

53. The relay terminal according to claim 46, wherein the processor is configured to load and run the one or more computer programs stored in the memory, to cause the relay terminal to perform:
receiving, on a PDU layer, the direct communication request message from the remote terminal.

54. A core network element, comprising:
a processor and a memory, wherein the memory is configured to store one or more computer programs, wherein the processor is configured to load and run the one or more computer programs stored in the memory, to cause the core network element to perform:
receiving a session report from a relay terminal;
wherein the session report comprises at least one of: an identifier of a protocol data unit (PDU) session, an identifier of a remote terminal, or a non-3^{rd} Generation Partnership Project (3GPP) access mode used by the remote terminal to access the relay terminal.

55. The core network element according to claim 54, wherein the non-3GPP access mode comprises at least one of a wireless local area network (WLAN) access mode or a Bluetooth access mode.

56. The core network element according to claim 54, wherein the identifier of the remote terminal in the session report is a subscriber concealed identifier (SUCI).

57. The core network element according to claim 54, wherein the core network element comprises a session management function (SMF) or a user plane function (UPF).
